(19) United States
(12) Patent Application Publication
(10) Pub. No.: US 2025/0371450 A1
(43) Pub. Date: Dec. 4, 2025

(54) CTC-BASED TRAIN OPERATION ADJUSTMENT METHOD AND APPARATUS

(71) Applicant: CASCO SIGNAL LTD., Shanghai (CN)

(72) Inventors: Zhenjie CHEN, Shanghai (CN); Yangjie ZHAO, Shanghai (CN); Yahui CAO, Shanghai (CN); Wei CHEN, Shanghai (CN); Ruichao SHEN, Shanghai (CN); Huabo ZHU, Shanghai (CN); Xin DU, Shanghai (CN); Lingzhi CAO, Shanghai (CN)

(73) Assignee: CASCO SIGNAL LTD., Shanghai (CN)

(21) Appl. No.: 18/876,686

(22) PCT Filed: Nov. 10, 2022
(86) PCT No.: PCT/CN2022/131078

§ 371 Date: Dec. 19, 2024

(30) Foreign Application Priority Data
Sep. 26, 2022 (CN) 202211176590.4

(51) Int. Cl. G06Q 10/0631

(52) U.S. Cl. CPC G06Q 10/06311

(57) ABSTRACT

A CTC-based train operation adjustment method and apparatus are provided. The adjustment apparatus includes a TDMS system interface server, a TD combined and shared intermediate database, a CTC system, a TD combined interface server and the like. The CTC system further includes a CTC system communication server, a running diagram platform and the like. The CTC-based train operation adjustment method and apparatus enable better cooperation of the CTC system and the running diagram platform thereof, and the TDMS system interface server; and by means of the TDMS system interface server and the TD combined and shared intermediate database, a plurality of basic diagrams are provided, so that a dispatcher can select an appropriate basic diagram to perform an operation task according to operation date or passenger demand, thereby making train operation regular and flexible

### CROSS REFERENCE TO THE RELATED APPLICATIONS

This application is the national phase entry of International Application No. PCT/CN2022/131078, filed on Nov. 10, 2022, which is based upon and claims priority to Chinese Patent Application No. 202211176590.4, filed on Sep. 26, 2022, the entire contents of which are incorporated herein by reference.

### TECHNICAL FIELD

The present invention relates to the technical field of railway construction, and in particular to a centralized traffic control (CTC)-based train operation adjustment method and apparatus.

### BACKGROUND

Railway transport dispatching is responsible for organizing passenger and freight transportation, ensuring key transportation, improving passenger and freight service quality and ensuring transportation safety, and plays an important role in completing railway transport production and operation tasks and increasing benefits for railway transport enterprises. A CTC system and a transportation dispatching management system (TDMS) are core application systems of railway informatization.

The CTC system, also called a dispatch centralized control system, is a technical device that a control center (dispatcher) performs centralized control on a signal device in a certain dispatching section and directly directs and manages train operation. The CTC system a highly automated dispatching command system that integrates computer technology, network communication technology and modern control technology, adopts an intelligent decentralized self-discipline design principle, takes a train operation adjustment technology as a center and gives consideration to train and shunting operations.

The TDMS system, that is, the transportation dispatching management system, provides a unified planning platform for each dispatching job, and each job data is calculated by the platform to generate a complete dispatching day (shift) plane and construct a global complete day (shift) plan.

At present, the CTC system adopts the unified standard of China Railway to acquire basic diagrams from the TDMS system, including a preview basic diagram, a common basic diagram and an archive basic diagram. The preview basic diagram is an edible basic diagram and is acquired and generated by the dispatcher from the TDMS system, and the system provides a data modification function. The common basic diagram is a currently efficient basic diagram, which takes effect after being started (changed) by the dispatcher and verified and is automatically invoked by the CTC system. The archive basic diagram can support multiple copies, the common basic diagram is archived and backed up by the dispatcher in combination with demand, thereby being invoked and used many times in the later period. According to the definition of an existing protocol, the basic diagrams acquired by the transportation dispatching (TD) interfaces (CTC system and TDMS system interface server) are static diagrams, and the requirement of flexibly adjusting the basic diagram mode cannot be met better.

### SUMMARY

To solve the problem that a basic diagram cannot be adjusted flexibly as required, the present invention provides a CTC-based train operation adjustment method and apparatus.

The CTC-based train operation adjustment apparatus provided in the present invention includes:
a TDMS system interface server, configured to generate an initial basic diagram including train schedule information, or generate a plurality of different basic diagrams and transmit the basic diagrams to a TD combined and shared intermediate database;
the TD combined and shared intermediate database, being in communication connection with the TDMS system interface server and configured to receive and store data information of the initial basic diagram or the basic diagrams;
a CTC system, including a CTC system communication server and a running diagram platform, where the CTC system communication server is used for the communication of the CTC system and is connected to a TD combined interface server and the running diagram platform, a dispatcher sends an application instruction for reading the basic diagrams by means of the running diagram platform and transmits the application instruction to the TD combined interface server by means of the CTC system communication server, and the dispatcher also selects an appropriate basic diagram from the plurality of basic diagrams by means of the running diagram platform and performs operation; and
the TD combined interface server, being in communication connection with the TD combined and shared intermediate database, where the TD combined interface server reads information data of the plurality of basic diagrams from the TD combined and shared intermediate database according to the application instruction and transmits the information data to the running diagram platform.

Optionally, the initial basic diagram further generates a basic diagram in the TD combined and shared intermediate database.

Optionally, the basic diagram includes train schedule information, and basic diagram name, train identity document (ID), dispatch console name, train number, running direction, train type, in flag, out flag, from station name, to station name and running role information.

Optionally, the application instruction includes dispatch console name information or train type information.

Optionally, the operation mode further includes operation date information;
the running role is in weeks; when the operation date is any day from Friday to Monday, the basic diagram is a first basic diagram;
when the operation date is any day from Tuesday to Thursday, the basic diagram is a second basic diagram; and
the train shifts in the first basic diagram are more than those in the second basic diagram.

Optionally, the TD combined interface server converts the read information data of the first basic diagram and the second basic diagram into an XML format and sends the information data to the running diagram platform.

Optionally, the running diagram platform can select one of the first basic diagram and the second basic diagram according to the operation date of the basic diagram to perform an operation task.

Optionally, the running diagram platform further can adjust the basic diagram according to the passenger demand;
when the operation date is any day from Tuesday to Thursday and the passenger demand increases, the running diagram platform can select the first basic to perform the operation task; and
when the operation date is any day from Friday to Monday and the passenger demand decreases, the running diagram platform can select the second basic diagram to perform the operation task.

Optionally, the running diagram platform can correspond the adjusted basic diagrams to the actual operation dates and store the adjusted basic diagram into the CTC system.

Optionally, the CTC system displays, queries and archives the basic diagrams by means of the running diagram platform.

Optionally, the CTC system can superpose the first basic diagram and the second basic diagram to form a basic general diagram.

Optionally, the CTC system further can perform a comparison operation on the basic diagrams or the basic general diagram;
the CTC system compares the basic diagrams or the basic general diagram by means of running line data and operation rule information; and
the running line data includes time points, entrance and exit, station track and information about whether to be open or not.

Optionally, the adjustment apparatus includes a CTC system side message queue (MQ) and a TDMS system side MQ; and
the TD combined interface server is in communication connection with the TDMS system interface server by means of the CTC system side MQ and the TDMS system side MQ.

Another technical solution of the present invention is to provide a CTC-based train operation adjustment method, suitable for any CTC-based train operation adjustment apparatus described above. The adjustment method includes the following processes:
step 1: enabling a TD combined interface server to be in communication connection with a CTC system communication server, a TDMS system interface server and a TD combined and shared intermediate database, respectively;
step 2: sending, by the CTC system, an application instruction for reading basic diagrams by means of a running diagram platform, and transmitting, by the CTC system communication server, the application instruction to the TD combined interface server;
step 3: reading, by the TD combined interface server, information data of a first basic diagram and a second basic diagram from the TD combined and shared intermediate database according to the application instruction, and transmitting, by the CTC system, the information data to a CTC running diagram; and
step 4: selecting, by the CTC system, the first basic diagram or the second basic diagram to perform an operation task.

Optionally, the step 2 further includes: transmitting, by the TD combined interface server, the application instruction to the TDMS system interface server by means of a CTC system side MQ and a TDMS system side MQ; and
transmitting, by the TDMS system interface server, the generated initial basic diagram or basic diagram to the TD combined and shared intermediate database.

Optionally, the step 2 further includes: enabling the initial basic diagram to further generate a basic diagram in the TD combined and shared intermediate database.

Optionally, the step 3 further includes: converting, by the TD combined interface server, the read information data of the first basic diagram and the second basic diagram into an XML format, and sending the XML format to the running diagram platform.

Optionally, the step 4 further includes: selecting, by the running diagram platform, the basic diagrams according to operation date or passenger demand.

Compared with the prior art, the CTC-based train operation adjustment method and apparatus provided in the present invention enable better cooperation of the CTC system and the running diagram platform thereof, and the TDMS system interface server; and by means of the TDMS system interface server and the TD combined and shared intermediate database, a plurality of basic diagrams are provided, so that a dispatcher can select an appropriate basic diagram to perform an operation task according to operation date or passenger demand, thereby making train operation regular and flexible.

### BRIEF DESCRIPTION OF THE DRAWINGS

FIG. 1 is a schematic diagram of a CTC-based train operation adjustment apparatus; and

FIG. 2 is a flowchart of a CTC-based train operation adjustment method.

### DETAILED DESCRIPTION OF THE EMBODIMENTS

The present invention is further described below with reference to the accompanying drawings and by means of the detailed description of preferred embodiments.

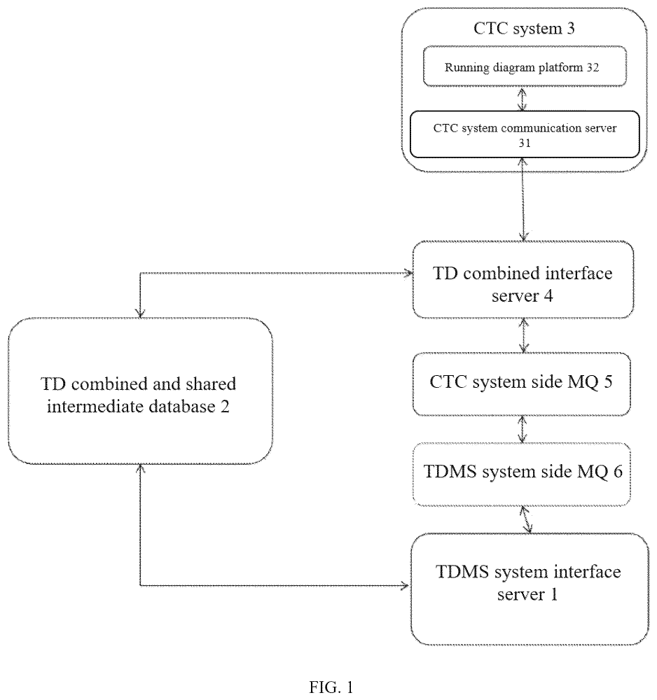

As shown in FIG. 1, a CTC-based train operation adjustment apparatus provided in the present invention includes: a TDMS system interface server 1, a TD combined and shared intermediate database 2, a CTC system 3, a TD combined interface server 4 and the like, where the TD combined interface server 4 is used for data exchange and sharing between the CTC system 3 and the TDMS system interface server 1; the TD combined interface server 4 performs data exchange and sharing by combining an MQ message with intermediate database exchange; and specifically, real-time data adopts an MQ message queue mode, and non-real-time data with a large data quantity adopts an intermediate database exchange mode.

The CTC system 3 further includes a CTC system communication server 31 and a running diagram platform 32. The CTC system communication server 31, as a core communication server, is used for the communication of the CTC system and is connected to the TD combined interface server 4 and the running diagram platform 32. A dispatcher sends an application instruction for reading the basic diagrams by means of the running diagram platform 32. The application instruction includes dispatch console name information or train type information, and is used for screening the basic diagrams. The application instruction is sent to the TD combined interface server 4 by the CTC system communication server 31.

In the embodiments of the present invention, the CTC-based train operation adjustment apparatus may further include a CTC system side MQ 5 and a TDMS system side MQ 6. The TD combined interface server 4 is in communication connection with the TDMS system interface server 1 by means of the CTC system side MQ 5 and the TDMS system side MQ 6.

The TDMS system interface server 1 generates an initial basic diagram or a plurality of different basic diagrams (sent by an intermediate database mode) according to a running plan, and transmits the initial basic diagram or the plurality of different basic diagrams to the TD combined and shared intermediate database 2. The TD combined and shared intermediate database 2 is in communication connection with the TDMS system interface server 1. The TD combined and shared intermediate database 2 is configured to receive and store data information of the initial basic diagram or the basic diagrams.

Specifically, the TDMS system interface server 1 generates the initial basic diagram only including train schedule information, and transmits the initial basic diagram to the TD combined and shared intermediate database to store. The initial basic diagram is further added with basic diagram name (TD_NAME), train ID (TRAIN_ID), dispatch console name (DDT_NAME), train number (TRAIN_NUM), running direction (RUN_DIR), train type (TRAIN_TYPE), in flag (IN_FLAG), out flag (OUT_FLAG), from station name (FROM_STA_NAME), to station name (TO_STA_NAME), running role (RUN_ROLE) and other information in the TD combined and shared intermediate database, and generates a corresponding basic diagram.

Or the TDMS system interface server 1 directly generates a plurality of basic diagrams including train schedule information and further including basic diagram name (TD_NAME), train ID (TRAIN_ID), dispatch console name (DDT_NAME), train number (TRAIN_NUM), running direction (RUN_DIR), train type (TRAIN_TYPE), in flag (IN_FLAG), out flag (OUT_FLAG), from station name (FROM_STA_NAME), to station name (TO_STA_NAME), running role (RUN_ROLE) and other information, and transmits the basic diagrams to the TD combined and shared intermediate database to store.

After data is stored in the database, the TDMS system interface server 1 sends a data storage completion notification message (sent by an MQ message queue mode), the data storage completion notification message is transmitted to the TD combined interface server 4 by means of the CTC system side MQ 5 and the TDMS system side MQ 6 and is transmitted to the CTC system communication server 31 by the TD combined interface server 4 to inform that the CTC system has completed storage and read can be performed.

The TD combined interface server 4 is in communication connection with the TD combined and shared intermediate database 2. The TD combined interface server 4 reads information data of the plurality of basic diagrams from the TD combined and shared intermediate database 2 according to the received application instruction.

The read basic diagrams include train schedule information, and information such as basic diagram name, train ID, dispatch console name, train number, running direction, train type, in flag, out flag, from station name, to station name and running role. The running role further includes operation date information. In the embodiments of the present invention, the running role is in weeks. The basic diagram with the operation date being any day of Friday, Saturday and Sunday is the first basic diagram, which usually has a relatively large number of train shifts to cope with the small travel rush on weekends. While the basic diagram with the operation date being any day of Tuesday, Wednesday and Thursday is the second basic diagram, the second basic diagram has a relatively small number of train shifts, thereby saving resources or costs. The train shifts in the first basic diagram are more than those in the second basic diagram.

In the embodiments of the present invention, the TD combined interface server 4 converts the information data of the first basic diagram and the second basic diagram of XD_TDX read from the TD combined and shared intermediate database 2 into an XML format, and transmits the information data to the running diagram platform 32; and the dispatcher selects the first basic diagram or the second diagram by means of the running diagram platform to perform the operation task. The dispatcher may also display, query and archive the basic diagrams by means of the running diagram platform 32.

The running diagram platform 32 selects the basic diagrams according to the operation date to perform the operation task. Specifically, when the operation date is any day of Friday, Saturday, Sunday and Monday, the running diagram platform 32 selects the first basic diagram to perform the operation task; and when the operation date is any day of Tuesday, Wednesday and Thursday, the running diagram platform 32 selects the second basic diagram to perform the operation task.

The running diagram platform 32 may adjust the basic diagrams according to passenger demand. For example, if the operation date is any day from Tuesday to Thursday, but belongs to holidays with busy passenger traffic such, such as Spring Festival travel rush, rush in summary holidays and festivals, the dispatcher can select the first basic diagram with relatively more train shifts by means of the running diagram platform 32 to perform the operation task, correspond the basic diagram to the date of the day and store the basic diagram into the CTC system for the subsequent CTC system service function. Similarly, if the operation date is any day of Friday, Thursday, Sunday and Monday, but the passenger demand decreases due to extreme weather or special circumstances, the dispatcher can select the second basic diagram with relatively few train shifts by means of the running diagram platform 32 to perform the operation task.

In the embodiments of the present application, the CTC system can superpose the first basic diagram and the second basic diagram to form a basic general diagram of one week. The CTC system further can perform a comparison operation on the basic diagrams or the basic general diagram as required. Specifically, the CTC system compares the basic diagrams or the basic general diagram according to running line data, such as time points, entrance and exit, station track and information about whether to be open or not, and operation rule information.

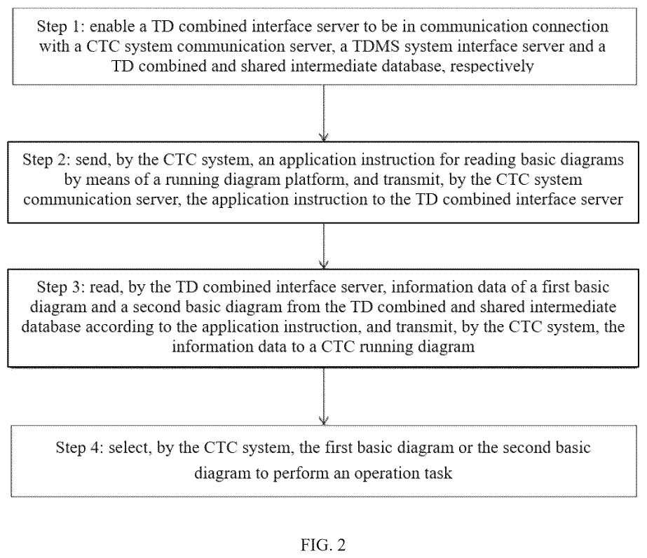

FIG. 2 is a flowchart of a CTC-based train operation adjustment method according to the present invention. The specific steps are as follows:
the TD combined interface server 4 is started, and the TD combined interface server 4 is in communication connection with the CTC system communication server 31, the TDMS system interface server 1 and the TD combined and shared intermediate database 2. The dispatcher sends an application instruction for reading the basic diagrams by means of the running diagram platform 32 included in the CTC system 3 so as to invoke the corresponding basic diagram. The application instruction is transmitted to the TD combined interface server 4 by the CTC system communication server 31. The TD combined interface server 4 reads basic diagram information from the TD combined and shared intermediate database according to the application instruction.

The TDMS system interface server 1 transmits the initial basic diagram only including train schedule information to the TD combined and shared intermediate database 2. The initial basic diagram is further added with basic diagram name (TD_NAME), train ID (TRAIN_ID), dispatch console name (DDT_NAME), train number (TRAIN_NUM), running direction (RUN_DIR), train type (TRAIN_TYPE), in flag (IN_FLAG), out flag (OUT_FLAG), from station name (FROM_STA_NAME), to station name (TO_STA_NAME), running role (RUN_ROLE) and other information in the TD combined and shared intermediate database 2, and generates corresponding basic diagrams.

Or the TDMS system interface server 1 directly generates the corresponding basic diagrams including train schedule information and further including basic diagram name (TD_NAME), train ID (TRAIN_ID), dispatch console name (DDT_NAME), train number (TRAIN_NUM), running direction (RUN_DIR), train type (TRAIN_TYPE), in flag (IN_FLAG), out flag (OUT_FLAG), from station name (FROM_STA_NAME), to station name (TO_STA_NAME), running role (RUN_ROLE) and other information, and transmits the basic diagrams to the TD combined and shared intermediate database 2.

After data is stored in the database, the TDMS system interface server 1 sends a data storage completion notification message to the TD combined interface server 4, and the data storage completion notification message is transmitted to the CTC system communication server 31 by the TD combined interface server 4 to inform that the CTC system has completed storage and read can be performed.

The TD combined interface server 4 reads information data of the first basic diagram and the second basic diagram from the TD combined and shared intermediate database 2 according to the application instruction. Furthermore, the TD combined and shared intermediate database 2 converts the read information data of the first basic diagram and the second basic diagram of XD_TDX into an XML format, and transmits the information data to the running diagram platform 32.

The dispatcher selects the first basic diagram or the second basic diagram by means of the running diagram platform 32 to perform the operation task. Specifically, the dispatcher selects the basic diagram according to the operation date, or the dispatcher selects the basic diagram according to the passenger demand.

The running diagram platform 32 may correspond the selected basic diagram to the date of the day, and store the basic diagram to the CTC system for the subsequent CTC system service function.

The CTC-based train operation adjustment method and apparatus provided in the present invention enable better cooperation of the CTC system and the running diagram platform thereof, and the TDMS system interface server; and by means of the TDMS system interface server and the TD combined and shared intermediate database, a plurality of basic diagrams are provided, so that a dispatcher can select an appropriate basic diagram to perform an operation task according to operation date or passenger demand, thereby making train operation regular and flexible.

Although the content of the present invention has been described in detail by means of the aforementioned preferred embodiments, it should be recognized that the above description should not be considered as limiting the present invention. Various modifications and alternatives to the present invention will become apparent to those skilled in the art upon reading the foregoing disclosure. Accordingly, the protection scope of the present invention shall be limited by the appended claims.

What is claimed is:

1. A centralized traffic control (CTC)-based train operation adjustment apparatus, comprising: a transportation dispatching management system (TDMS) interface server, configured to generate an initial basic diagram comprising train schedule information, or generate a plurality of basic diagrams and transmit the plurality of basic diagrams to a transportation dispatching (TD) combined and shared intermediate database; wherein the TD combined and shared intermediate database is in a communication connection with the TDMS interface server and configured to receive and store data information of the initial basic diagram or the plurality of basic diagrams; a CTC system, comprising a CTC system communication server and a running diagram platform, wherein the CTC system communication server is configured for a communication of the CTC system and is connected to a TD combined interface server and the running diagram platform, a dispatcher sends an application instruction for reading the plurality of basic diagrams by means of the running diagram platform and transmits the application instruction to the TD combined interface server by means of the CTC system communication server, and the dispatcher further selects an appropriate basic diagram from the plurality of basic diagrams by means of the running diagram platform and performs an operation; and the TD combined interface server, wherein the TD combined interface server is in the communication connection with the TD combined and shared intermediate database, wherein the TD combined interface server reads information data of the plurality of basic diagrams from the TD combined and shared intermediate database according to the application instruction and transmits the information data to the running diagram platform.

2. The CTC-based train operation adjustment apparatus according to claim 1, wherein the initial basic diagram further generates a basic diagram in the TD combined and shared intermediate database.

3. The CTC-based train operation adjustment apparatus according to claim 1, wherein the plurality of basic diagrams comprise the train schedule information, a basic diagram name, a train identity document (ID), a dispatch console name, a train number, a running direction, a train type, an in flag, an out flag, a from station name, a to station name, and running role information.

4. The CTC-based train operation adjustment apparatus according to claim 3, wherein the application instruction comprises dispatch console name information or train type information.

5. The CTC-based train operation adjustment apparatus according to claim 3, wherein the running role information comprises operation date information; the running role information is in weeks; when operation date is a day from Friday to Monday, the basic diagram is a first basic diagram; when the operation date is a day from Tuesday to Thursday, the basic diagram is a second basic diagram; and the-train shifts in the first basic diagram are more than train shifts in the second basic diagram.

6. The CTC-based train operation adjustment apparatus according to claim 5, wherein the TD combined interface server converts the information data of the first basic diagram and the second basic diagram into an XML format and sends the information data to the running diagram platform.

7. The CTC-based train operation adjustment apparatus according to claim 5, wherein the running diagram platform is allowed for selecting one of the first basic diagram and the second basic diagram according to the operation date of the basic diagram to perform an operation task.

8. The CTC-based train operation adjustment apparatus according to claim 7, wherein the running diagram platform is further allowed for adjusting the basic diagram according to a passenger demand; when the operation date is the day from Tuesday to Thursday and the passenger demand increases, the running diagram platform is allowed for selecting the first basic diagram to perform the operation task; and when the operation date is the day from Friday to Monday and the passenger demand decreases, the running diagram platform is allowed for selecting the second basic diagram to perform the operation task.

9. The CTC-based train operation adjustment apparatus according to claim 8, wherein the running diagram platform is further allowed for corresponding adjusted basic diagrams to actual operation dates and storing the adjusted basic diagrams into the CTC system.

10. The CTC-based train operation adjustment apparatus according to claim 9, wherein the CTC system displays, queries, and archives the plurality of basic diagrams by means of the running diagram platform.

11. The CTC-based train operation adjustment apparatus according to claim 8, wherein the CTC system is allowed for superposing the first basic diagram and the second basic diagram to form a basic general diagram.

12. The CTC-based train operation adjustment apparatus according to claim 11, wherein the CTC system is further allowed for performing a comparison operation on the plurality of basic diagrams or the basic general diagram; and the CTC system compares the plurality of basic diagrams or the basic general diagram by means of running line data and operation rule information, wherein the running line data comprises time points, entrance and exit, a station track, and information about whether to be open or not.

13. The CTC-based train operation adjustment apparatus according to claim 1, further comprising a CTC system side message queue (MQ) and a TDMS side MQ, wherein the TD combined interface server is in the communication connection with the TDMS interface server by means of the CTC system side MQ and the TDMS side MQ.

14. A CTC-based train operation adjustment method, suitable for the CTC-based train operation adjustment apparatus according to claim 1, comprising the following processes: step 1: allowing the TD combined interface server to be in the communication connection with the CTC system communication server, the TDMS interface server, and the TD combined and shared intermediate database, respectively; step 2: sending, by the CTC system, the application instruction for reading plurality of basic diagrams by means of the running diagram platform, and transmitting, by the CTC system communication server, the application instruction to the TD combined interface server; step 3: reading, by the TD combined interface server, the information data of a first basic diagram and a second basic diagram from the TD combined and shared intermediate database according to the application instruction, and transmitting, by the CTC system, the information data to a CTC running diagram; and step 4: selecting, by the CTC system, the first basic diagram or the second basic diagram to perform an operation task.

15. The CTC-based train operation adjustment method according to claim 14, wherein the step 2 further comprises: transmitting, by the TD combined interface server, the application instruction to the TDMS interface server by means of a CTC system side MQ and a TDMS side MQ; and transmitting, by the TDMS interface server, the initial basic diagram or the plurality of basic diagrams to the TD combined and shared intermediate database.

16. The CTC-based train operation adjustment method according to claim 15, wherein the step 2 further comprises: allowing the initial basic diagram to further generate a basic diagram in the TD combined and shared intermediate database.

17. The CTC-based train operation adjustment method according to claim 14, wherein the step 3 further comprises: converting, by the TD combined interface server, the read information data of the first basic diagram and the second basic diagram into an XML format, and sending the information data to the running diagram platform.

18. The CTC-based train operation adjustment method according to claim 14, wherein the step 4 further comprises: selecting, by the running diagram platform, the plurality of basic diagrams according to an operation date or a passenger demand.
